(19) United States
(12) Patent Application Publication
(10) Pub. No.: US 2026/0006097 A1
(43) Pub. Date: Jan. 1, 2026

(54) CUSTOM FILTERING AND ROUTING OF LLM CONTENT

(71) Applicant: Synchrony Bank, Stamford, CT (US)

(72) Inventors: Christopher Pastor, Stamford, CT (US); Parthiban Akkini, Stamford, CT (US)

(21) Appl. No.: 19/252,101

(22) Filed: Jun. 27, 2025

Related U.S. Application Data
(60) Provisional application No. 63/665,673, filed on Jun. 28, 2024.

(51) Int. Cl. H04L 67/50; G06F 40/40

(52) U.S. Cl. CPC H04L 67/50; G06F 40/40

(57) ABSTRACT

Systems and methods for custom filtering of large language model content are provided. A request associated with a user device may be received at a platform associated with a secure network environment. The request may concern usage of an online service associated with a large language model (LLM). A user interface may be generated that includes an input field. Prompt data may be provided by the user device via the input field of the user interface. The prompt data may be determined to include sensitive data in accordance with a data model trained to recognize patterns associated with sensitive data. The received prompt data may be modified to remove the sensitive data. The modified prompt data may be routed over a communication network to the online service associated with the LLM.

### CROSS REFERENCE TO RELATED APPLICATIONS

This application claims the benefit of U.S. Provisional Patent Application 63/665,673, filed Jun. 28, 2024, entitled “CUSTOM FILTERING AND ROUTING OF LLM CONTENT,” which is incorporated herein by reference in its entirety for all purposes.

### BACKGROUND OF THE INVENTION

### 1. Field of the Invention

The present invention generally relates to large language models (LLMs). More specifically, the present invention relates to custom filtering and routing of LLM content.

### 2. Description of the Related Art

Presently available large language models (LLMs) are computational models trained based on large datasets to recognize and generate text in response to prompts. Multiple LLMs—such as GPT-40 (associated with OpenAI's ChatGPT) and LLaMA (large language model Meta AI)—are made available to the public through online channels. Use of such LLMs generally include providing one or more prompts via a chat interface, whereupon the LLM may analyze the prompts, identify patterns with respective probabilities, and generate output in accordance with its training.

As users provide series of prompts to such publicly available models, such data may subsequently be used to further train and refine results of the model. Because such data is fed back into publicly available models and used to produce new outputs in response to subsequent queries from the public, LLM usage may therefore risk exposure or uses of sensitive data that users (and their respective employers and/or other affiliated entities) did not intend.

There is, therefore, a need in the art for improved systems and methods for custom filtering and routing of LLM content.

### SUMMARY OF THE CLAIMED INVENTION

Embodiments of the present invention allow for custom filtering and routing of LLM content. A request associated with a user device may be received at a platform associated with a secure network environment. The request may concern usage of an online service associated with a large language model (LLM). A user interface may be generated that includes an input field. Prompt data may be provided by the user device via the input field of the user interface. The prompt data may be determined to include sensitive data in accordance with a data model trained to recognize patterns associated with sensitive data. The received prompt data may be modified to remove the sensitive data. The modified prompt data may be routed over a communication network to the online service associated with the LLM.

Some implementations may further include authenticating a user of the user device based on credentials associated with the request, and determining that usage of the online service is permitted in accordance with one or more policies stored in memory. The determination of how to route to the (modified) prompt data may be based on elements in the prompt and/or a profile determined to be associated with the user device. Where a plurality of different online services associated with different LLMs are available for routing, the routing may further be based on the profile. A request from a different user device associated with a different profile may be routed to a different online service associated with a different LLM based on the different profile.

Profiles may also be the basis for generating one or more prompt options to present in the user interface for selection. As such, a different user device associated with a different profile may be presented with a different set of prompt options based on the different profile. The profiles may include user data, role, department or other affiliation within an organization, etc., which may determine what policies are applicable with respect to usage of LLMs. In some implementations, a new profile may be generated for the user device based on a plurality of requests associated with the user device that have been received, routed, and modified. A subsequent request associated with the user device may be routed based on the profile, and a subsequent request associated with another user device (e.g., identified as being similar to the user) may also be routed based on an association with the profile.

In some implementations, output data received from the online service may be modified based on data from an internal reference database, which may be one of a plurality of different internal reference databases. As such, while the LLMs to which prompt data may be routed may be external to the platform or may be hosted in private sandbox environments, internal resources may also be used to improve output results. Where there are multiple different databases, one particular internal reference database to use may be selected based on the profile associated with the user device. New workflows may be generated for routing subsequent requests that are similar to the received request based on the data from the internal reference database and the modified output data.

### BRIEF DESCRIPTION OF THE FIGURES

FIG. 1 illustrates an exemplary network environment in which systems for custom filtering and routing of LLM content may be implemented.

FIG. 2 is a swim lane diagram illustrating an exemplary series of interactions between different devices during custom filtering and routing of LLM content.

FIGS. 3A-F illustrate exemplary user interfaces that may be presented on a user device during custom filtering and routing of LLM content.

FIG. 4 is a flowchart illustrating an exemplary method for custom filtering of LLM content.

FIG. 5 is a flowchart illustrating an exemplary method for custom routing of LLM content.

FIG. 6 illustrates an example processor-based system with which some aspects of the subject technology can be implemented, according to some aspects of the disclosed technology.

### DETAILED DESCRIPTION

Embodiments of the present invention allow for custom filtering and routing of LLM content. A request associated with a user device may be received at a platform server associated with a secure network environment. The request may concern usage of an online service associated with a large language model (LLM). A user interface may be generated that includes an input field. Prompt data may be provided by the user device via the input field of the user interface. The prompt data may be determined to include sensitive data in accordance with a data model trained to recognize patterns associated with sensitive data. Sensitive data may include, but is not limited to, personally identifiable information (PII), primary account numbers (PAN), employee records, user credentials, and the like. Such pattern matching may be based on models, formats, templates, data structures, etc., associated with known types of sensitive data. The received prompt data may then be modified to remove the sensitive data. For example, phone numbers may be associated with format templates specifying that phone numbers correspond to a set of numerals with a certain number of digits. Similarly, templates for types of addresses may be used to identify when addresses are part of prompts. The modified prompt data may be routed over a communication network to the online service associated with the LLM, thereby allowing usage of LLMs in safe and controlled manner that avoids exposure of sensitive data.

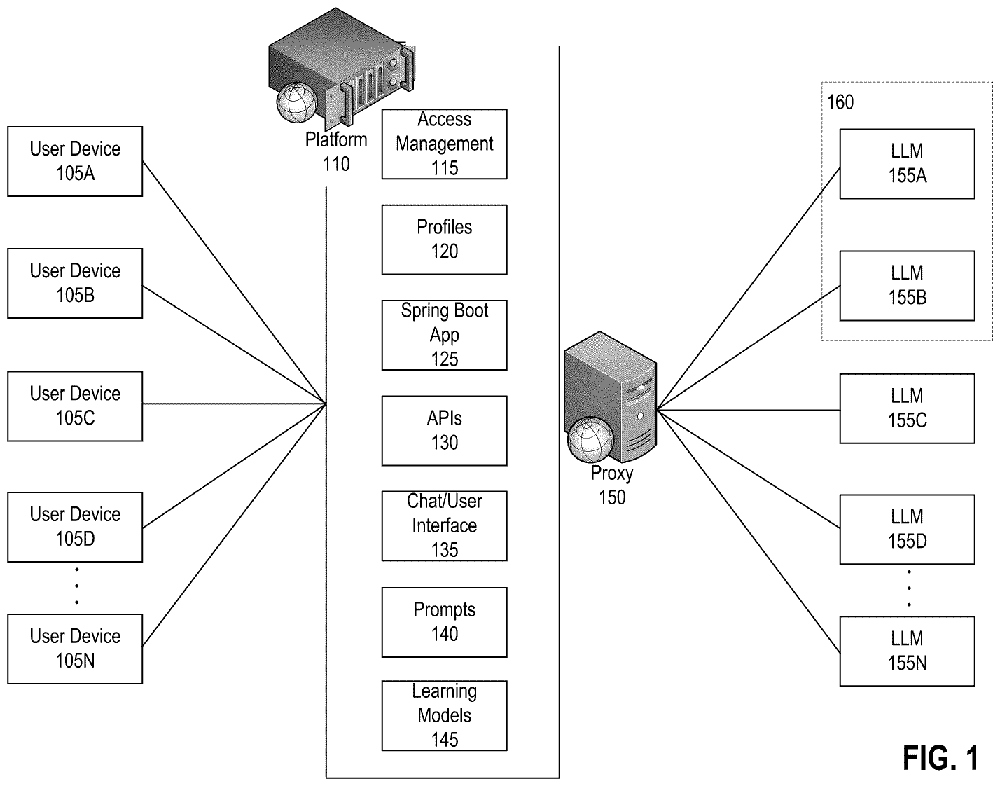

FIG. 1 illustrates an exemplary network environment 100 in which systems for custom filtering and routing of LLM content may be implemented. As illustrated, network environment 100 may include user devices 105A-N, platform server(s) 110—which may host cloud-based services and resources, such as access management 115, profiles 120, spring boot application 125, application programming interfaces (APIs) 130, chat/user interface 135, prompts 140, and learning models 145—proxy server(s) 150, and multiple different large language models (LLMs) 155A-N, some of which may reside in private or dedicated sandbox environments 160.

The devices, etc., illustrated in network environment 100 may communicate over one or more communication networks, including local, proprietary networks (e.g., an intranet or local area network (LAN)) and/or may be a part of a larger wide-area network (e.g., wide area network (WAN) such as the Internet). The Internet is a broad network of interconnected computers and servers allowing for the transmission and exchange of Internet Protocol (IP) data between users connected through network service providers. Examples of network service providers are the public switched telephone network, a cable service provider, a provider of digital subscriber line (DSL) services, or a satellite service provider.

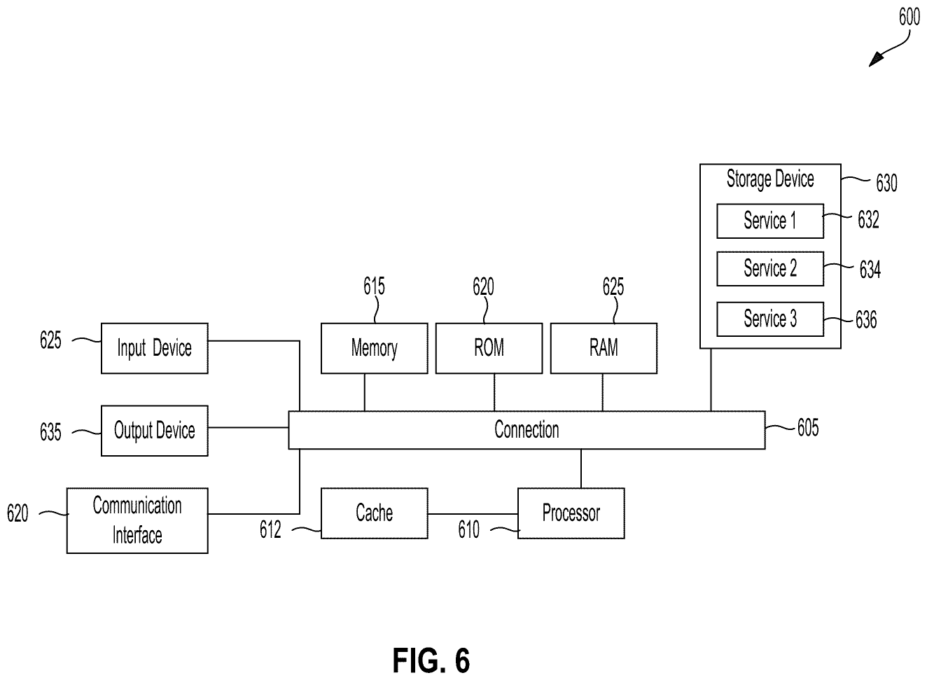

Users may use any number of different electronic user devices 105A-N, such as general purpose computers, mobile phones, smartphones, personal digital assistants (PDAs), portable computing devices (e.g., laptop, netbook, tablets), desktop computing devices, handheld computing device, or any other type of computing device capable of communicating over communication network. User devices 105A-N may also be configured to access data from other storage media, such as memory cards or disk drives as may be appropriate in the case of downloaded services. User devices 105A-N may include standard hardware computing components such as network and media interfaces, non-transitory computer-readable storage (memory), and processors for executing instructions that may be stored in memory. These user devices 105A-N may also run using a variety of different operating systems (e.g., iOS, Android), applications or computing languages (e.g., C++, JavaScript). An exemplary user device 105A-N is described in detail herein with respect to FIG. 6. Each user device 105A-N may be associated with one or more users permitted access to data, services, and resources hosted and/or managed by platform server 110.

One or more platform servers 110 may be responsible for communicating with user devices 105A-N to provide one or more platform-level services. Platform server 110 may include any type of server or other computing device as is known in the art, including standard hardware computing components such as network and media interfaces, non-transitory computer-readable storage (memory), and processors for executing instructions or accessing information that may be stored in memory (described in further detail in relation to FIG. 6). The functionalities of multiple servers may be integrated into a single server. Any of the aforementioned servers (or an integrated server) may take on certain client-side, cache, or proxy server characteristics. These characteristics may depend on the particular network placement of the server or certain configurations of the server.

Such platform servers 110 may be implemented on one or more cloud servers to provide cloud-based services (including related data, applications, and other resources) in accordance with platform policies. For example, the platform servers 110 may support authenticating users of user devices 105A-N, managing user profiles (e.g., which may specify types of access and use policies), APIs, and data models, and providing chat-based services. The chat-based services may further utilize any combination of existing LLMs 155A-N in order to analyze prompts and generate responsive outputs. While existing LLMs 155A-N may each be associated with their own respective chat applications, a hosted chat-based service (e.g., hosted by platform server 110) may be controlled and secured in a more tailored manner (e.g., in accordance with platform-specific policies and profiles) than is possible with public LLMs.

Access management 115 may control authentication and authorization processes for any of the services and applications associated with platform server 110. In particular, access management 115 may validate the users of user devices 105A-N (including internal and external or remote devices) and corresponding internal and external applications that are communicating from within internal networks or through external communication networks (e.g., Internet) in accordance with platform-level policies, as well as more specific policies associated with different user roles, devices, departments, use cases, etc. While illustrated as part of platform server 110, access management 115 may also be integrated with associated authentication servers and identity data stores. Access management 115 may also include application access management (AAM) and Sessions, Identity and Access Management (SIAM) modules associated with enabling single sign-on (SSO) authentication for multiple different applications and users across an enterprise. In exemplary implementations, a user device 105A-N may provide SSO credentials to access management 115, which may validate that the user device 105A-N is authorized to access a requested service or application.

In some implementations, when an internal application or external application is initially generated by the platform or enterprise for use by different entities (such as user devices 105A-N), the platform server 110, through access management 115, can define a set of permissions corresponding to the one or more LLMs 155A-N that may be leveraged by the application to generate a response to a provided input. For example, when a user, through a user device 105A-N, accesses the platform or enterprise to configure an application that can leverage one or more LLMs 155A-N to provide a desired functionality, the platform or enterprise may associate different LLMs 155A-N with the new application. In some instances, the platform may assign a unique identifier to this new application and associate the different LLMs 155A-N with this unique identifier.

Profiles 120 may include any collection of information and settings associated with specific users, user groups, user roles, use cases, applications, etc., associated with use of LLMs. Such profiles 120 may be stored in one or more databases in memory and retrieved when a user device 105A-N is identified as being associated with an individual and/or application whose access is governed by a particular profile. In some implementations, validation by access management 115 may result in identification of a profile 120 to use for managing usage of the LLM. For example, a profile 120 may be identified for an employee in the marketing department that may specify certain levels of access to marketing data and marketing applications and services. Such access may include use of certain LLMs to develop marketing content and campaigns. Another example may include a profile 120 identified for an executive in the governance role, who may need access to governance data and LLM services associated with analyzing and generating governance statements.

In addition to specifying types and levels of access, profiles 120 may further specify types of prompts commonly used by users associated with the profile 120. A set of prompt options may be identified for a particular user device 105A-N based on the associated profile 120, and the prompt options may be presented for selection. In some implementations, the prompts may be generated and/or identified from among past prompts, which may have already been filtered to remove sensitive data. Thus, the user of user device 105A-N may not be required to type out the prompts themselves (which may risk the inadvertent entry of sensitive data), but instead select from a set of options.

Profiles 120 may further be used to identify specific LLM services to use in generating output for a given prompt and to route the (filtered) prompt data to the identified LLM services. As a result, a profile 120 associated with marketing may specify that the prompt be routed to LLMs associated with generating marketing content, while a profile 120 associated with governance may specify that the prompt be routed to a different LLM associated with generating governance documents. For new users, relevant profiles 120 may be identified based on any combination of user data (which may be identified during authentication by access management 115) and the types of prompts that such users may submit in a request for an LLM service. In some instances, new profiles may also be generated based on historical data (e.g., past series of prompts, feedback, online behaviors) associated with a particular user, as well as data associated with past users that are identified as similar to the user.

Spring boot app(s) 125 may be inclusive of microservices, web application, and other programs that include instructions executable to provide custom filtering and flexible routing of content associated with LLMs. As discussed in further detail herein, spring boot app 125 may be executed to initiate launch of chat/user interface 135, analyze prompt data provided via chat/user interface 135, perform any filtering of the prompt data as needed, and route the filtered prompt to a specific LLM in accordance with applicable policies and profiles. Spring boot app 125 may route the prompt data to any of a plurality of different LLMs using an associated API (e.g., REST API, Open AI API).

A spring boot app 125 may be tasked with performing retrieval-augmented generation (RAG) that optimizes the output of an LLM 145 for a particular platform or enterprise based on internal knowledge bases and resources, which allows for associated users to integrate the use of LLMs into their existing workflows and to create new workflows for their specific use cases. As different resources may be used for the different use cases, there may also be multiple different RAGs available in interactions with LLMs.

APIs 130 may allow for different applications and devices in network environment 100 to communicate with each other. One or more APIs 130 may be stored in a database in memory. Each of the APIs 130 may be specific to the particular operating language, system, platform, protocols, etc., of the platform server 110, as well as the user devices 105A-N, and other devices of network environment 100. In a network environment 100 that may include multiple different types of user devices 105A-N, servers 110, LLMs and other services, etc., there may likewise be a corresponding number of APIs 130 that allow for various combinations of formatting, conversion, compression/decompression, and other cross-device and cross-platform communication processes for providing and processing content and other services to different user devices 105A-N, which may each respectively use different operating systems, protocols, etc., to process such content. As such, applications and services in different formats may be made available so as to be compatible with a variety of different user devices 105A-N. The APIs 130 may further include additional information, such as metadata, about the accessed content or service to the user device 105.

In some implementations, the APIs 130 include an authorization API that can automatically authenticate different applications accessing the platform. Furthermore, the authorization API, upon successful authentication of an application, may determine whether the application is authorized to access the LLMs 155A-N associated with the platform to obtain a response to a submitted user query or other request (as submitted by a user through their user device 105A-N). In some examples, when an application is initially generated by the platform for use by different entities, the platform, through the authorization API, can define a set of permissions corresponding to the one or more LLMs 155A-N that may be leveraged by the application to generate a response to a provided input. For example, as described in greater detail herein, when a user accesses the platform to configure a new application that can leverage one or more LLMs 155A-N to provide a desired functionality, the platform may associate different LLMs with the new application. In some instances, the platform may assign a unique identifier to this new application or microservice and associate the different LLMs with this unique identifier. Thus, when an application accesses the platform, the application may provide this unique identifier to the authorization API, which may evaluate the unique identifier to determine whether application is associated with one or more LLMs 155A-N that the application is authorized to leverage in order to obtain a response to a given input.

In some implementations, the APIs 130 further include a moderation API for initial screening of an input provided by a user device 105A-N (such as through an application executing on the user device 105A-N or other interface). Through the moderation API, the platform server 110 may evaluate the received input to determine whether the input comports with any applicable rules for eligible inputs. For instance, in response to a new input, the platform server 110, through the moderation API, may apply natural language processing (NLP) or any other text parsing algorithm or executable code to automatically parse the new input. Through this parsing of the new input, the moderation API may identify particular terms that may be used to determine an intent expressed by a user of an application executing on a user device 105A-N.

In some implementations, the moderation API determines whether the user intent expressed in the provided input comports with a set of applicable rules corresponding to permissible inputs or intents. The set of applicable rules may specify what intents may be processed by the platform (such as through corresponding LLMs 155A-N associated with the application executing on the user device 105A-N) as well as any actions that are to be performed in the event that a user submits an impermissible input through the application. For example, if the input submitted by a user includes a query as to who why the Oklahoma City Thunder don't deserve to win a title, the moderation API may determine that the user's intent (e.g., basketball-related information) is not associated with any permissible intents as defined through the set of applicable rules. Accordingly, the moderation API may reject the user input as being irrelevant to the purpose of the application. Accordingly, the moderation API may transmit a response to the user to indicate that the submitted input could not be processed. In some instances, the moderation API may automatically generate a response that admonishes the user for submitting an impermissible input through the application. In some instances, the moderation API may automatically terminate the communication session between the particular instance of the application and the platform in response to the impermissible input.

Chat/user interface 135 may include any variety of graphical user interfaces that may communicate and interact with a user. Chat/user interface 135 may be integrated with access management 115 and launched when a request for an LLM-based service is identified as being from a validated user device 105A-N. Chat/user interface 135 may present communications and content to the user device 105, as well as prompt data inputted by the user device 105 (including selected prompt data) and subsequent outputs generated based on the prompt data. While some public LLMs may have their own respective chat/user interface, the chat/user interface 135 hosted by platform server 110 and managed by spring boot app 125 allows for interception, analysis, and if needed, filtering of prompt data before such prompt data is provided to an (external) LLM. In addition, chat/user interface 135 may also present different prompt options to different users in accordance with their respective profiles and/or applicable policies.

Prompts 140 may be stored in memory and include any variety of default prompts, historical prompts, and associated prompt data. Different sets of the prompts 140 may be associated with different users, user groups, profiles, etc. For example, a particular user may be identified as having historically inputted certain prompts or types of prompts (e.g., a marketing manager may have used prompts requesting different types of marketing content). Such historical data may be tracked and modeled (e.g., by training a learning model 145 using such historical data of the user and/or similar users) to generate prompt options for the user during future interactions with LLMs. The prompt options and user selections therefrom may also be tracked to modify the selection or arrangement of prompt options presented to the user in future sessions, which may also correspond to streamlined workflows requiring fewer input actions from the user. In some implementations, new prompts may also be generated under new combinations of conditions by training and applying learning models 145 to identify patterns in prompt formulation under different conditions. Different users may thus be presented with a different set of prompts 140 via chat/user interface 135 under different conditions.

Learning models 145 may be trained to identify patterns associated with LLM usage. For example, learning models 145 may be trained to identify patterns associated with sensitive data, so that the sensitive data may be filtered from prompt data sent to LLMs. The learning model may be trained using training data that includes large data sets that include different types of sensitive data (e.g., that a platform or enterprise wish to avoid exposing). When a user device 105 receives prompt data entered into a chat/user interface 135, therefore, the prompt data may be provided to spring boot app 125 for analysis using the trained learning model 145. The trained learning model 145 may thus identify when prompt data includes a subset of data likely to be sensitive. The identification allows spring boot app 125 to filter the subset of data identified as likely sensitive from the prompt data before the prompt data is sent to an LLM. As such, the LLM may receive prompt data for use in generating output, but is prevented from receiving sensitive data.

In some implementations, a learning model 145 may be trained to identify a relevant profile for a user, which may then be used to identify relevant prompts to present to the user, workflows to initiate for the user, and LLMs for routing the prompts. Different use cases may be identified and used to select from among different profiles, LLMs, prompts, RAGs, metrics, etc. Training data may include historical data regarding series of prompt inputs, prompt options, prompt selections, routes and outputs by LLMs, and user data. A specific user or specific type of user (e.g., performing marketing tasks) may exhibit repeated patterns of behavior in relation to their interactions with LLMs. The learning model 145 may be trained to recognize such patterns and correlate the patterns to a specific profile (e.g., associated with marketing). The profile may also be updated over time as new patterns emerge from a growing body of historical data. New profiles may also be generated based on such new patterns.

In some implementations, the learning model 145 is further trained to generate recommendations corresponding to different LLMs 155A-N that may be associated with a new application or that may be otherwise used to process a received input. For instance, when a user submits a request to generate a new application (internal or external), the platform may analyze any provided application requirements, as well as any provided sample data, to generate one or more recommendations corresponding to different LLMs that may be associated with the new application. To generate these one or more recommendations, the platform server 110 may process the request and the provided requirements and sample data through the learning model 145. This learning model 145 may be dynamically trained using supervised, unsupervised, or hybrid training techniques. For instance, a dataset of sample application requirements (e.g., known or historical requirements, hypothetical requirements, combinations of known/historical and hypothetical requirements, etc.), sample input data (e.g., known or historical input data, hypothetical input data, combinations of known/historical and hypothetical input data, etc.), and pools of LLMs may be analyzed using a clustering or classification algorithm to classify the sample requirements and input data according to a set of different classifications (e.g., different LLMs). For instance, the learning model 145 may be dynamically trained by converting the set of requirements and provided input data into a set of vectorial values corresponding to different vectors of similarity that may be associated with different LLMs. For instance, each LLM may be associated with a set of known vectorial values along the different vectors of similarity in a multidimensional space. The learning model 145 may compare the set of vectorial values corresponding to the request (e.g., the set of provided requirements and input data) to the set of known vectorial values associated with the different LLMs to generate a pool of different LLMs that may be recommended to the user for the new application. This pool may be generated by identifying a set of LLMs having a set of known vectorial values that are within a proximity threshold of the set of vectorial values corresponding to the request. This proximity may be calculated or measured using, for example, cosine similarity, dot product, Euclidean distance, or any other vector distance function. LLMs having a vector distance within the proximity threshold may be selected for recommendation. In some instances, the learning model 145 may rank the identified LLMs according to their vector proximity to the set of vectorial values corresponding to the set of requirements and input data provided by the user. Example classification and/or clustering algorithms that may be implemented include Support Vector Machines (SVM), k-Nearest Neighbor (KNN) algorithms, logistic regression algorithm, random forest models, Naïve Bayes models, linear regression models, decision tree models, gradient boosting machine models, and the like.

Learning models may also be updated based on feedback and associated analytics based on the feedback, which may include subsequent input data, user data, or profile data. Where input data and profiles are being analyzed, the model 145 may further apply pattern recognition to a set of prompts to identify common characteristics and to predict which profile may be correlated with more positive feedback, better or more prolonged user engagement, or other outcome metric. User feedback may indicate certain preferences or ways in which the prompt options and outputs may be selected, modified, and/or presented in a manner best-fitting the needs and preferences of the user. Such user feedback may be used not only to tailor subsequent outputs for the specific user and prompt, but also for users and prompts identified as sharing similar respective attributes. In that regard, the learning model 145 may not only be constructed for or customized to a particular user, but may be used for user groups that share similarities. Further, the associations or patterns may be affirmed by querying the user for feedback on whether the output was suitable, relevant, or otherwise positively received by the user and utilize the user feedback to further update and tune the model 145.

Proxy server 150 may be inclusive of any server that acts as an intermediary in interactions and communications with any of the LLMs. 155A-N. The proxy server 150 may include any type of server or other computing device as is known in the art, including standard hardware computing components such as network and media interfaces, non-transitory computer-readable storage (memory), and processors for executing instructions or accessing information that may be stored in memory (described in further detail in relation to FIG. 6).

LLMs 155A-N may be inclusive of any large language model trained to perform certain tasks. For example, some LLMs may be used to conduct interactive sessions with users in which one or more prompts from the user elicit generation of responsive content (e.g., using generative artificial intelligence techniques). Such LLMs may therefore have been trained to analyze language (e.g., such as found in prompts), identify patterns, make predictions based on the identified patterns, gauge probabilities of the predictions, and generate an output response based on the predictions.

The LLMs 155A-N may include proprietary and open-source LLMs that may be available to different entities associated with the platform. Access to these different proprietary and open-source LLMs may be regulated by the platform server 110 such that certain LLMs may only be available to certain entities. For example, for an application implemented on a user device to support an internal marketing function, the application may be restricted to LLMs that may be implemented to support this internal marketing function. As another illustrative example, the platform may identify which LLMs are available for a particular application based on the roles associated with the expected users of the application.

LLMs may be constructed, trained, applied, and tuned by using neural network architecture and deep learning techniques to analyze training sets of data (e.g., regarding language usage). Neural network architecture may include an input layer that includes input data, such as prompt data, user data, profile data, etc., as well as hidden layers associated with the desired processing outcome and/or rendering intent. The neural network may further include an output layer that provides an output (e.g., responsive content) resulting from the processing performed by the hidden layers. The multiple layers of the neural network may further include interconnected nodes each representing a piece of information. Information associated with the nodes is shared among the different layers and each layer retains information as information is processed.

The LLMs 155A-N are, in some implementations, dynamically trained using datasets comprising large corpora of sample inputs (e.g., historical inputs, hypothetical inputs, combinations of historical and hypothetical inputs, etc.), sample embeddings corresponding to the sample inputs, and sample responses to the sample inputs (e.g., historical responses, hypothetical responses, combinations of historical and hypothetical responses, etc.). The LLMs 155A-N may be initialized with a first set of values corresponding to different hyperparameters or other coefficients that, in combination, are used to derive an output given a sample input. For instance, the platform may initialize a set of coefficients or other hyperparameters randomly according to a Gaussian distribution or non-Gaussian distribution. Using this initial iteration of the LLMs 155A-N, the platform may process the dataset of sample inputs to generate an output. This output may specify, for each sample input, a response to the input. The LLMs 155A-N may compare the output (e.g., predicted responses) to the expected responses included in the dataset. Based on this comparison, the LLMs 155A-N may dynamically update the values corresponding to the different hyperparameters or other coefficients and again process the dataset to generate new outputs. This process may be repeated numerous times until an iteration of the LLMs 155A-N is obtained that satisfies one or more accuracy or predictability thresholds.

Information can be exchanged between nodes through node-to-node interconnections between the various layers. In some cases, each node or interconnection between nodes can have a weight that is a set of parameters derived from training the neural network. For example, an interconnection between nodes can represent a piece of information learned about the interconnected nodes. The interconnection can have a numeric weight that can be tuned (e.g., based on a training dataset), allowing the neural network to be adaptive to inputs and able to learn as more data is processed. LLMs may use machine learning (including deep learning) to perform probabilistic analyses of unstructured input data and to recognize patterns and correlations that have been learned during training in accordance with training data.

In some implementations, certain LLMs may be implemented within private or dedicated sandbox environments. For example, as illustrated in FIG. 1, sandbox 160 may be inclusive of a computing environment that may be isolated from certain devices, systems, or networks. As illustrated in FIG. 1, LLMs 155A and 155B may be implemented in a sandbox 160 that is isolated and therefore restricted from access by unauthorized users and user devices. In some implementations, the LLMs 155A and 155B in the sandbox 160 may be secured and dedicated to use by specific users and user devices (e.g., associated with a particular tenant). Such LLMs may not be publicly available to external users that are not associated with the tenant, which may add another layer of protection against exposure of sensitive data. Even if the prompt data were used to tune the dedicated LLMs, therefore, external users would not be able to access the tuned LLMs, submit prompt data, or receive generated output based on the tuned LLMs.

In some implementations, the LLMs available for a particular application are determined based on the input data that may be processed by these LLMs. For instance, if an application is being implemented to process potentially sensitive data (e.g., PII, PANs, employee records, etc.), the platform may limit the pool of available LLMs 155A-N to those that are not publicly available to external users that are not associated with those authorized to utilize this application or microservice. Further, the platform may limit this pool of available LLMs 155A-N to those that do not use this potentially sensitive data for training of the LLMs, which may cause inadvertent exposure of the potentially sensitive data to unauthorized users. In some instances, the platform may limit the pool of available LLMs 155A-N to those that are implemented within a private or sandbox environment (such as sandbox 160), whereby any input data processed by the LLMs within this private or sandbox environment is prevented from becoming publicly available for tuning of LLMs and for unauthorized users.

In some implementations, the LLMs 155A-N are trained in conjunction with RAG to improve the predictability of the LLMs 155A-N in generating responses that accurately resolve the intents expressed in received inputs. As an illustrative example, in addition to evaluating the LLMs 155A-N according to linguistic metrics (e.g., Bilingual Evaluation Understudy (BLEU) scores, language fluency metrics, semantic consistency metrics, etc.), the platform may determine whether the LLMs 155A-N are accurately leveraging the available knowledge bases generated using the internal and external data sources to generate outputs (e.g., responses) that address the sample intents expressed in the sample inputs. For instance, the platform may evaluate the output generated by the LLMs 155A-N to determine whether the LLMs 155A-N are correctly converting the sample communications/messages into a set of embeddings and identifying appropriate data sources from the knowledge bases according to this set of embeddings (e.g., correctly matching the set of embeddings to knowledge base embeddings corresponding to data sources usable to address the underlying intents, etc.). Based on this evaluation, the platform may dynamically update the one or more LLMs 155A-N as described above to improve the responses generated by these one or more LLMs 155A-N.

In some implementations, in response to receiving a proposed response from the LLMs 155A-N, access management 115 may evaluate the proposed response, as well as any information associated with the user that submitted the input and with the application through which the input was submitted, to determine whether the proposed response may be communicated to the user through the application. As noted above, in response to a user input, access management 115 may assess the user's role within an organization or other entity to identify the permissible intents that may be communicated by the user. As an illustrative example, if the user is an employee that is not authorized to access payroll data associated with the organization (e.g., the user's role is not associated with payroll functions, etc.), access management 115 may prohibit the user from submitting a query corresponding to these impermissible payroll functions. In an embodiment, access management 115 may similarly evaluate a proposed response to determine whether the proposed response includes any information or other data that the user, based on their defined role, is not authorized to access. If the proposed response includes impermissible information or other data, access management 115 may reject the proposed response. This rejection of the proposed response may serve as feedback that may be used to dynamically retrain the LLMs 155A-N.

It should be noted that while LLMs are used extensively throughout the present disclosure for the purpose of illustration, the systems and methods described herein can be implemented for any alternative and/or additional machine learning algorithms and artificial intelligence processes. For instance, the systems and methods described herein, in addition to be applicable for different LLMs, may be applicable to masked language models (MLMs) and other generative artificial intelligence processes.

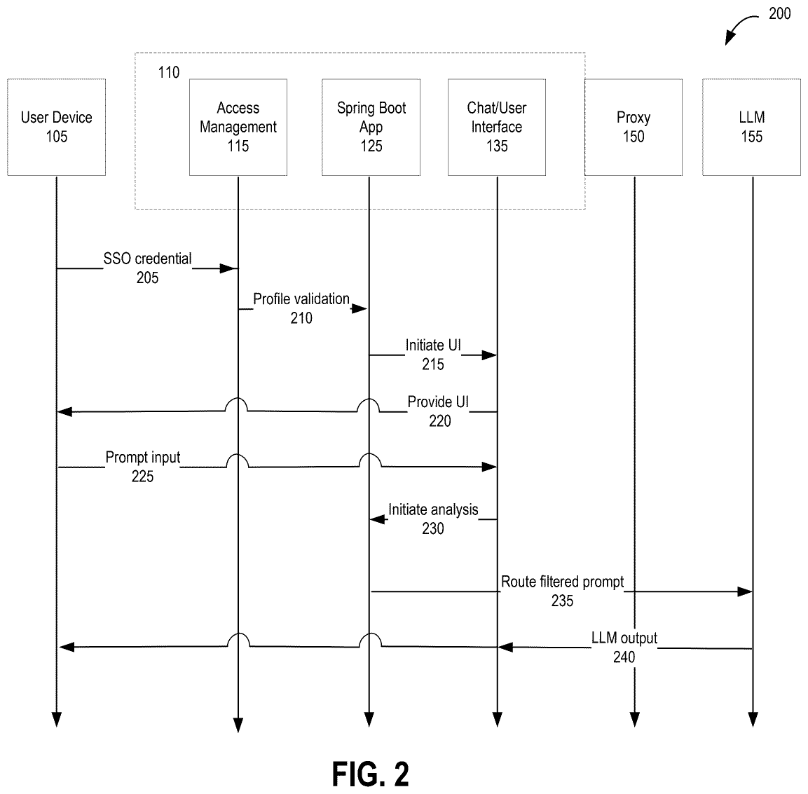

FIG. 2 is a swim lane diagram illustrating an exemplary series of interactions 200 between different devices during custom filtering and routing of LLM content. User device 105 may provide SSO credentials 205 to access management 115 of platform server 110, which may accompany a request to use an LLM to generate output. The access management 115 may verify the SSO credentials 205 and identify that the user device 105 is authorized to access the resources of platform. In addition, access management 115 may also provide profile validation 210 information to spring boot app 125. Such profile validation 210 information may include a specific profile itself or information that spring boot app 125 can use to identify and retrieve a profile.

Spring boot app 125 may provide an initiation or launch instruction to the chat/user interface 135, which generates a user interface display with an input field. The user interface display 220 may be provided to user device 105, and a user of user device 105 may provide prompt input 225 in the input field of the user interface display. The prompt input 225 may trigger analysis 230 by the spring boot app 125 (such as through the moderation API described above). Such analysis may identify the presence of sensitive data in the prompt input 225 and filter the sensitive data out of the prompt input 225. The filtered prompt 235 may then be routed via proxy server 150 to a particular LLM 155, which may generate output based on the filtered prompt 235. In some instances, the LLM output may be modified or otherwise optimized based on RAG techniques before being provided to the user device 105. For instance, in some implementations, the platform implements a RAG processor for further processing and generation of tailored responses to the prompt input. The RAG processor may maintain a knowledge base repository or other datastore that is associated with a data pipeline (e.g., myriad external and/or internal data sources, etc.) made available to the platform for generating responses to any provided inputs. In some implementations, the RAG processor, through this knowledge base repository or other datastore, maintains different embeddings corresponding to different internal and external data sources made available to the RAG processor through the data pipeline for generating responses to received inputs. For instance, if the RAG processor is provided with access to one or more external human resource systems maintained by an organization that implements the platform, the RAG processor may automatically access or scrape any available data sources within these one or more external human resource systems and, accordingly, convert the data included in these data sources into different sets of embeddings that may be used to dynamically generate responses to received inputs. The RAG processor may be granted access to a significant number of internal and/or external data sources (e.g., private/organization-based data sources, publicly available data sources, etc.) such that the knowledge base repository or other datastore maintained by the RAG processor may include embeddings corresponding to millions or billions of different data sources. Thus, the RAG processor, in some embodiments, is implemented using thousands, tens of thousands, or more processors that are configured to operate in parallel to access any available data sources and generate corresponding embeddings.

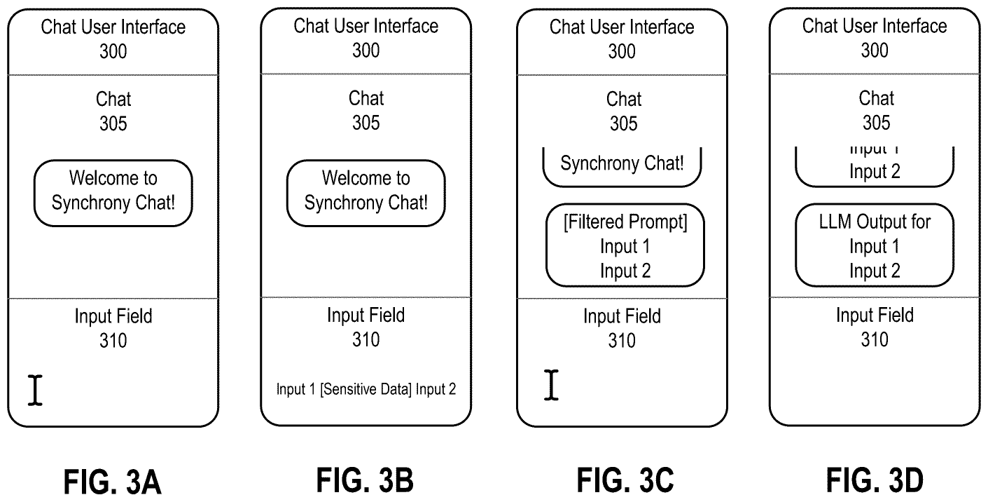

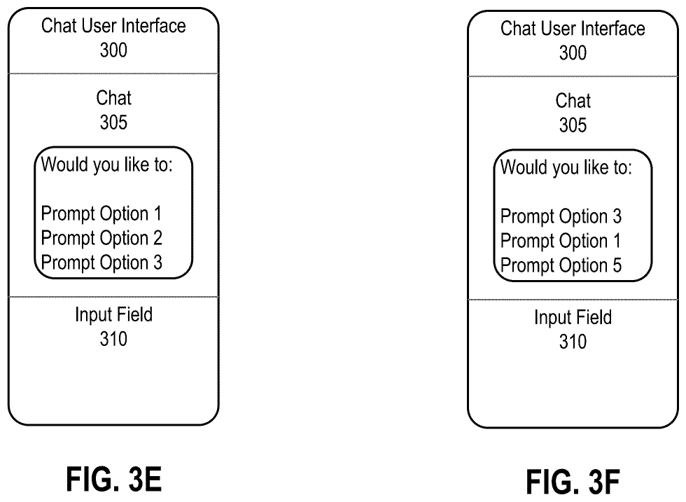

FIGS. 3A-E illustrate exemplary user interfaces 300 that may be presented on a user device during custom filtering and routing of LLM content. As illustrated, the chat user interface 300 may include a chat stream 305 and an input field 310. The chat stream 305 may display messages, user prompts, prompt options, and LLM outputs associated with a particular use session.

The chat stream 305 of FIG. 3A illustrates a welcome message to the user, which may be generated and presented at the user device upon launch. FIG. 3B illustrates that input data has been entered into the input field 310 and that the input data includes input portions 1 and 2, as well as sensitive data. The user of user device may submit the input data for eventual conveyance to the LLM. Instead of sending the unfiltered input data to an LLM, however, the input data may first be provided to spring boot app (such as the spring boot app 125 described above in connection with FIG. 1) for analysis, identification of the sensitive data, and filtering of the input data to remove the identified sensitive data.

As noted above, the spring boot app, through a moderation API, may perform initial screening of an input provided through a user device to determine whether the input comports with any applicable rules for eligible inputs. For example, when the input data has been entered into the input field 310, the spring boot app, through the moderation API, may apply NLP or any other text parsing algorithm or executable code to automatically parse the input data. Through this parsing of the input data, the moderation API may identify the input portions 1 and 2, as well as the sensitive data. The moderation API may further determine whether the input portions 1 and 2, as well as the sensitive data, comport with a set of applicable rules corresponding to permissible inputs or intents. The set of applicable rules may specify what inputs or intents may be processed by the platform (such as through corresponding LLMs associated with the chat user interface 300) as well as any actions that may be performed in the event that an impermissible input has been provided through the input field 310. Returning to the example illustrated in FIG. 3B, where the input includes sensitive data, the moderation API may detect this sensitive data and determine that the input does not comport with the set of applicable rules. Accordingly, the moderation API may evaluate the set of applicable rules to determine what action is to be taken as a result of the input including the sensitive data. For instance, as illustrated in FIG. 3C, the action may include filtering out the sensitive data from the input. As another illustrative example, the action may include rejecting the input entirely and updating the user interface 300 to indicate that the submitted input could not be processed. As yet another illustrative example, the moderation API may automatically generate a response that admonishes the user for submitting an input that includes the sensitive data. In yet another illustrative example, the moderation API may automatically terminate the use session in response to the sensitive data.

In FIG. 3C, the chat stream 305 illustrates that the prompt entered into the input field 310 has been filtered to remove the sensitive data, leaving only input portions 1 and 2. Meanwhile, the filtered prompt—including only input portions 1 and 2—may be provided to an LLM to prompt generation of output. FIG. 3D illustrates a chat stream 305 that includes the LLM output that has been generated based on the input portions 1 and 2 only and not the sensitive data.

In some instances, prior to providing the LLM output, access management associated with the platform server may evaluate the LLM output, as well as any information associated with the user that submitted the input data through the input field 310, to determine whether the LLM output may be communicated to the user through the chat stream 305. As noted above, in response to a user input, access management may assess the user's role within an organization or other entity to identify the permissible intents or inputs that may be communicated by the user. Returning to an earlier illustrative example, if the user is an employee that is not authorized to access payroll data associated with the organization (e.g., the user's role is not associated with payroll functions, etc.), access management may prohibit the user from submitting a query corresponding to these impermissible payroll functions. In an embodiment, access management may similarly evaluate the LLM output to determine whether the LLM output includes any information or other data that the user, based on their defined role, is not authorized to access. If the LLM output includes impermissible information or other data, access management may reject the LLM output and prevent presentation of this LLM output through the chat stream 305. This rejection of the proposed response may serve as feedback that may be used to dynamically retrain the LLMs. Further, this rejection prevent inadvertent dissemination of data that the user is not authorized to view or otherwise access.

FIG. 3E and FIG. 3F illustrate alternative user interfaces 300 that may be generated for selection. Depending on the use case or profile identified for a particular user device 105, different prompt options may be identified as being relevant and included in the chat stream 305. Further, the prompt options may also be rearranged for different users, use cases, and profiles. These different prompt options may be identified and arranged by access management based on the user's role within an organization or other entity and according to the permissible intents or inputs that may be communicated by the user through the user interface 300.

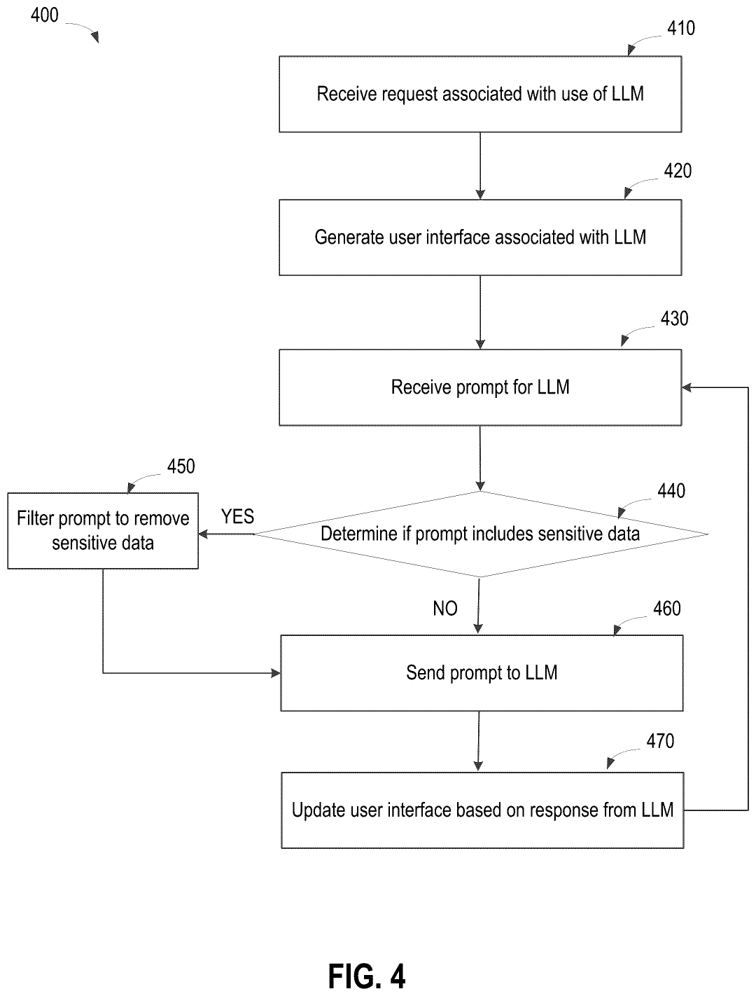

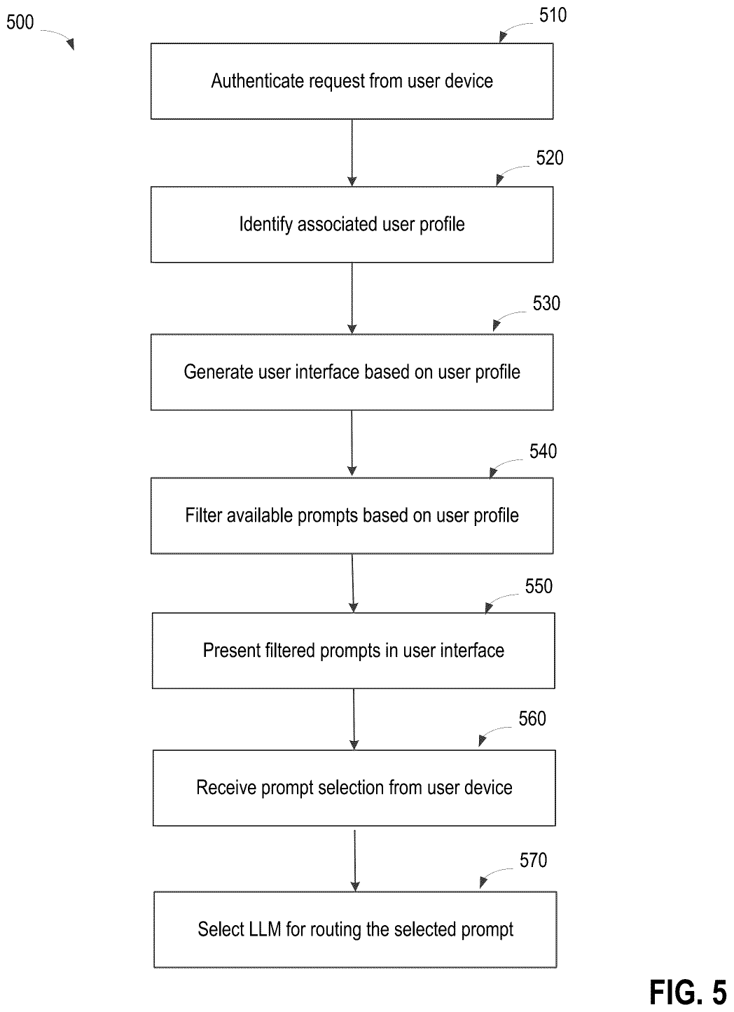

FIG. 4 is a flowchart illustrating an exemplary method for custom filtering of LLM content, and FIG. 5 is a flowchart illustrating an exemplary method for custom routing of LLM content. The methods 400 and 500 of FIGS. 4-5 may be embodied as executable instructions in a non-transitory computer readable storage medium including but not limited to a CD, DVD, or non-volatile memory such as a hard drive. The instructions of the storage medium may be executed by a processor (or processors) to cause various hardware components of a computing device hosting or otherwise accessing the storage medium to effectuate the method. The steps identified in FIGS. 4 and 5 (and the order thereof) are thus exemplary and may include various alternatives, equivalents, or derivations thereof including but not limited to the order of execution of the same.

Method 400 of FIG. 4 begins with step 410, in which a request associated with use of an LLM may be received at a platform server 110 associated with a particular entity or enterprise. The request may be sent over a communication network from a user device 105, which may be associated with a user affiliated with the entity or enterprise. The user may wish to access LLMs in order to perform certain tasks, and the entity or enterprise may wish to safeguard its data and resources during such access and usage.

In step 420, platform server 110—via spring boot app 125—may launch a user interface associated with LLM usage, but based on platform-specific chat/user interface 135 rather than any particular LLM. As such, a single chat/user interface 135 may be used to submit prompts that may be routed to different LLMs based on input, user, use case, profile, etc.

In step 430, an input prompt may be received when a user inputs and submits input data into an input field of the chat/user interface 135. Instead of being directly sent to an LLM, however, the input prompt may be analyzed by spring boot app 125 to determine whether sensitive data is included in step 440. If sensitive data is determined to be included, the method may proceed to step 450 where the prompt is filtered to remove the sensitive data. The prompt data may then be sent to an LLM in step 460. Where no sensitive data is identified in step 440, the method may proceed directly to step 460 where the prompt is sent to the LLM without filtering.

In step 470, responsive output generated by the LLM based on the provided input may be returned and used to update the chat/user interface 135 for presentation to the user of user device 105. As such, user device 105 may be provided with LLM output while avoiding the exposure of sensitive data.

It should be noted that the method 400 may include additional and/or alternative steps. For instance, in some examples, if a submitted input prompt violates one or more applicable rules or policies (e.g., the input prompt includes sensitive data, etc.), a response may be transmitted to the user of the user device 105 to indicate that the submitted input prompt could not be processed. Further, in some instances, the user may be admonished for submitting an impermissible input prompt. Additionally, or alternatively, if the user submits an impermissible input prompt, the use session through which the user submitted their input prompt may be automatically terminated to prevent further user interaction with the platform.

As another example of an additional and/or alternative step that may be performed as part of the method 400, the responsive output generated by the LLM may be evaluated prior to being returned and used to update the chat/user interface 135 for presentation to the user. This evaluation may be performed in order to prevent dissemination of sensitive data or other data that the user is not authorized to view or otherwise access. If the responsive output includes any sensitive data or other data that the user is not authorized to access, the responsive output may be rejected, thereby preventing dissemination of the responsive output to the user. This rejection of the responsive output may serve as feedback that may be used to dynamically retrain or otherwise fine tune/update the LLM to reduce the likelihood of the LLM including this sensitive or other impermissible data in its responsive outputs.

In some instances, the responsive output may be further evaluated according to different linguistic metrics (e.g., BLEU scores, language fluency metrics, semantic consistency metrics, etc.) to determine whether the responsive output is likely to be understood by the user. For instance, the platform may maintain, for each of these different linguistic metrics, a set of thresholds that may need to be satisfied in order for the responsive output to be accepted for presentation to the user. If the responsive output fails any of these thresholds, the platform may reject the responsive output and provide feedback that may be used to dynamically retrain the LLM to improve the likelihood of the LLM generating new responsive outputs that satisfy the set of thresholds and, thus, are likely to be understood by different users.

Method 500 of FIG. 5 concerns profile-based routing of prompt data to one of a plurality of different available LLMs. The first step 510 involves authentication of a request for LLM usage that may have been sent from a particular user device 105 and associated with SSO credentials. The user device 105 may be authenticated as being authorized to access services and resources at platform server 110 based on such credentials. For instance, when a user, through their user device 105, submits an input (e.g., a communication, a request, etc.), access management of the platform server 110 may obtain identifying information associated with the user. This identifying information may include a user name, user credentials, user roles within one or more organizations, user location, user demographics, and the like. Access management may evaluate this identifying information according to platform-level policies, as well as more specific policies associated with different user roles, devices, departments, use cases, and the like, to determine whether the user is authorized to access the services and resources at platform server 110. For instance, access management may include AAM and SIAM modules associated with enabling SSO authentication for the different applications associated with the platform. These AAM and SIAM modules may process any provided user credentials to authenticate a corresponding user and to validate that this user is authorized to access these services and resources at the platform server 110.

In step 520, a user profile is identified for the authenticated user device 105. The user profile may be specific to a user of user device 105 or may pertain to a group of users with similar use cases (e.g., marketing, governance) in relation to LLM usage. New profiles may be developed as new use cases and conditions arise. In some instances, the platform server 110 may maintain a set of profiles corresponding to different applications associated with the platform and that may be executed to access the services and resources at platform server 110. A profile corresponding to a particular application may include information and settings associated with specific users, user groups, user roles, use cases, and the like. In response to a user input submitted through a particular application, access management may query this set of profiles to identify a profile corresponding to the user and the application to determine whether the user is authorized to interact with the LLMs associated with the application. The profile may specify, for the particular user, certain levels of access to different types of data, applications, and services associated with the platform. Such levels of access may include use of certain LLMs for obtaining responses to submitted inputs. If access management determines, based on this evaluation of the profile, that the user is not authorized to access the services and resources at platform server 110, access management may prevent user access to these services and resources. For instance, access management may return a response to the application and that indicates that the user is not authorized to access the services and resources at the platform server 110. Thus, access management improves the security of the platform by preventing unauthorized access to these different services and resources. Furthermore, this reduces the number of unauthorized inputs processed by the platform server 110, thereby reducing the processing required to generate responses to valid inputs.

In step 530, a chat/user interface 135 may be generated based on the identified profile. As discussed herein, a single chat/user interface 135 may be used to submit prompts that may be routed to different LLMs. In some instances, the chat/user interface 135 may be generated according to the different LLMs that are associated with the application used by the user to access the platform server 110.

In step 540, different messages and prompt options may be identified for a particular user of user device 105. The identification of which messages, prompt options, and other chat content to present at user device 105 in step 550 may be based on the identified profile. Further, profiles may also govern workflows in which automated messages and prompt options are initiated and presented within chat/user interface 135.

In step 560, a prompt selection may be received from user device 105. The user of user device 105 may have selected one of multiple presented prompts in chat/user interface 135 or may have inputted a different prompt altogether. In some implementations, the prompt may be filtered if determined to include sensitive data as described in relation to the method 400 of FIG. 4.

In step 570, the prompt may be routed to a selected LLM. As discussed herein, there may be multiple different available LLMs to which a prompt may be routed. The selection of which LLM to route a prompt may be based on a variety of factors, including user, use case, profile, prompt input or selection, or any combination of the foregoing. As noted above, the application through which the prompt is provided may be associated with a profile that indicates the particular LLMs associated with the application. Based on these identified LLMs, the prompt may be transmitted to the specific systems that implement the identified LLMs and to which the prompt may be routed. Thus, once the LLM is selected, the prompt data may be routed to the selected LLM via proxy server 150. The selected LLM may then generate and return output based on the prompt data.

FIG. 6 illustrates an example processor-based system with which some aspects of the subject technology can be implemented. For example, processor-based system 600 that can be any computing device that is configured to generate and/or display customized video content for a user and/or which is used to implement all, or portions of, a multimedia editing/playback platform, as described herein. By way of example, system 600 can be a personal computing device, such as a smart phone, a notebook computer, or a tablet computing device, etc. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (CPU or processor) 610 and connection 605 that couples various system components including system memory 615, such as read-only memory (ROM) 620 and random-access memory (RAM) 625 to processor 610. Computing system 600 can include a cache of high-speed memory 612 connected directly with, in close proximity to, and/or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 625, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 620, which can generally govern and manage the user input and system output.

The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a Blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

Storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

By way of example, processor 610 may be configured to execute operations for custom filtering and routing of LLM content. By way of example, processor 610 may be provisioned to execute any of the operations discussed above with respect to methods 400 or 500, respectively described in relation to FIGS. 4 and 5.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method for custom filtering of large language model content, the computer-implemented method comprising:
receiving a request associated with a user device, the request concerning usage of an online service associated with a large language model (LLM);
generating a user interface that includes an input field;
receiving prompt data, wherein the prompt data is associated with a prompt provided by the user device via the input field of the user interface;
determining that the prompt data includes sensitive data using a data model trained to recognize patterns associated with sensitive data;
modifying the prompt data to remove the sensitive data; and
routing the modified prompt data over a communication network to the online service associated with the LLM.

2. The computer-implemented method of claim 1, further comprising:
authenticating a user of the user device based on credentials associated with the request; and
determining that usage of the online service is permitted in accordance with one or more policies stored in memory.

3. The computer-implemented method of claim 1, further comprising:
determining to route the modified prompt data to the online service based on the prompt.

4. The computer-implemented method of claim 1, further comprising:
identifying a profile associated with the user device, wherein usage of the online service is permitted in accordance with one or more policies associated with the profile.

5. The computer-implemented method of claim 1, wherein a request from a different user device is routed to a different online service associated with a different LLM, and wherein the different user device is routed to the different online service based on a different profile associated with the different user device.

6. The computer-implemented method of claim 1, further comprising:
generating one or more prompt options to present in the user interface, wherein the prompt data includes a selection of a prompt option from among the one or more prompt options.

7. The computer-implemented method of claim 1, further comprising:
generating a profile for the user device based on a plurality of requests associated with the user device.

8. The computer-implemented method of claim 1, further comprising:
modifying output data received from the online service based on data from an internal reference database.

9. The computer-implemented method of claim 1, wherein the modified prompt data is routed to the online service based on a determination that the LLM is hosted in a private sandbox accessible to the user device.

10. A system comprising:
a communication interface that receives a request associated with a user device over a communication network, the request concerning usage of an online service associated with a large language model (LLM); and
a processor that executes instructions stored in memory, wherein the processor executes the instructions to:
generate a user interface that includes an input field;
receive prompt data, wherein the prompt data is associated with a prompt provided by the user device via the input field of the user interface;
determine that the prompt data includes sensitive data using a data model trained to recognize patterns associated with sensitive data;
modify the prompt data to remove the sensitive data; and
route the modified prompt data over a communication network to the online service associated with the LLM.

11. The system of claim 10, wherein the processor executes further instructions to:
authenticate a user of the user device based on credentials associated with the request; and
determine that usage of the online service is permitted in accordance with one or more policies stored in the memory.

12. The system of claim 10, wherein the processor executes further instructions to:
determine to route the modified prompt data to the online service based on the prompt.

13. The system of claim 10, wherein the processor executes further instructions to:
identify a profile associated with the user device, wherein usage of the online service is permitted in accordance with one or more policies associated with the profile.

14. The system of claim 10, wherein a request from a different user device is routed to a different online service associated with a different LLM, and wherein the different user device is routed to the different online service based on a different profile associated with the different user device.

15. The system of claim 10, wherein the processor executes further instructions to:
generate one or more prompt options to present in the user interface, wherein the prompt data includes a selection of a prompt option from among the one or more prompt options.

16. The system of claim 10, wherein the processor executes further instructions to:
generate a profile for the user device based on a plurality of requests associated with the user device.

17. The system of claim 10, wherein the processor executes further instructions to:
modify output data received from the online service based on data from an internal reference database.

18. The system of claim 10, wherein the modified prompt data is routed to the online service based on a determination that the LLM is hosted in a private sandbox accessible to the user device.

19. A non-transitory computer-readable storage medium, having embodied thereon a program executable by a processor to perform a method for custom filtering of large language model content, the method comprising:
receiving a request associated with a user device, the request concerning usage of an online service associated with a large language model (LLM);
generating a user interface that includes an input field;
receiving prompt data, wherein the prompt data is associated with a prompt provided by the user device via the input field of the user interface;
determining that the prompt data includes sensitive data using a data model trained to recognize patterns associated with sensitive data;
modifying the prompt data to remove the sensitive data; and
routing the modified prompt data over a communication network to the online service associated with the LLM.

20. The non-transitory computer-readable storage medium of claim 19, further comprising instructions executable to:
authenticating a user of the user device based on credentials associated with the request; and
determining that usage of the online service is permitted in accordance with one or more policies stored in memory.

21. The non-transitory computer-readable storage medium of claim 19, further comprising instructions executable to:
determine to route the modified prompt data to the online service based on the prompt.

22. The non-transitory computer-readable storage medium of claim 19, further comprising instructions executable to:
identify a profile associated with the user device, wherein usage of the online service is permitted in accordance with one or more policies associated with the profile.

23. The non-transitory computer-readable storage medium of claim 19, wherein a request from a different user device is routed to a different online service associated with a different LLM, and wherein the different user device is routed to the different online service based on a different profile associated with the different user device.

24. The non-transitory computer-readable storage medium of claim 19, further comprising instructions executable to:
generate one or more prompt options to present in the user interface, wherein the prompt data includes a selection of a prompt option from among the one or more prompt options.

25. The non-transitory computer-readable storage medium of claim 19, further comprising instructions executable to:
generate a profile for the user device based on a plurality of requests associated with the user device.

26. The non-transitory computer-readable storage medium of claim 19, further comprising instructions executable to:
modify output data received from the online service based on data from an internal reference database.

27. The non-transitory computer-readable storage medium of claim 19, wherein the modified prompt data is routed to the online service based on a determination that the LLM is hosted in a private sandbox accessible to the user device.
